(19) United States
(12) Patent Application Publication
(10) Pub. No.: US 2024/0232739 A1
(43) Pub. Date: Jul. 11, 2024

(54) METHOD FOR ANALYSING A CONSTRUCTION PROJECT, RECORDING ASSEMBLY, CONSTRUCTION DEVICE AND RECORDING SYSTEM

(71) Applicant: Kewazo GmbH, Garching (DE)

(72) Inventors: Alimzhan RAKHMATULIN, Garching (DE); Sebastian WEITZEL, Garching (DE); Alexander Liu CHENG, Garching (DE)

(21) Appl. No.: 18/559,347

(22) PCT Filed: Dec. 30, 2021
(86) PCT No.: PCT/EP2021/087844

§ 371 Date: Nov. 7, 2023

(30) Foreign Application Priority Data
May 7, 2021 (DE) 10 2021 112 046.2

(51) Int. Cl. G06Q 10/0631; G06Q 10/20; G06Q 50/08

(52) U.S. Cl. CPC G06Q 10/0631; G06Q 10/20; G06Q 50/08

(57) ABSTRACT

A method of analyzing at least one construction project is described, in which data relating to a component of a construction-site machine used in the construction project is acquired in an automatic manner via a sensor. The acquired data is transmitted to an evaluation unit. The transmitted data is evaluated to obtain evaluation results. The transmitted data is correlated with a mass of the construction materials and/or construction components transported by the construction-site machine to evaluate the progress of the construction project, and/or construction-site machine data is derived from the transmitted data, in particular taking machine-specific data of the construction-site machine into account. Furthermore, a recording assembly for a construction-site machine transporting construction materials and/or construction components, a construction-site machine, and a recording system are described.

### FIELD OF THE INVENTION

The invention relates to a method of analyzing a construction project. In addition, the invention relates to a recording assembly for a construction-site machine transporting construction materials and/or construction components on a construction site. Furthermore, the invention relates to a construction-site machine and a recording system.

### BACKGROUND OF THE INVENTION

On a construction site, in particular a large construction site, construction-site machines are used, among other things, for transporting construction materials and/or construction components, which must transport the corresponding construction materials and/or construction components higher and higher with advancing construction progress. The construction-site machines used for this purpose may be hoists, cranes, winches or scaffolding transport systems, for example the transport system known from document WO 2018/206566 A1, which comprises carriage modules designed as robots and travelling automatically along a rail system. These robots are also referred to as “liftbots”.

The progress of the construction project and the material used so far can be derived, among others, from the height of the section of the construction project that has already been completed, the corresponding data having been documented manually to date. In this respect, the progress of the construction project can only be determined with considerable effort, since an employee, for example the construction site manager, must be on site to determine the corresponding progress of the construction project. In addition, the determination is prone to errors, since errors can occur during the manual transfer of the data.

Also known from the prior art are, among other things, simulations in which the respective construction progress of the construction project can be determined based on the simulation. However, the simulations are based on assumptions which do not necessarily have to correspond to reality.

The object of the invention is to be able to determine the progress of the construction project in a simple and accurate manner.

### SUMMARY OF THE INVENTION

According to the invention, the object is achieved by a recording assembly for a construction-site machine transporting construction materials and/or construction components on a construction site, comprising at least one sensor which is set up to automatically acquire data relating to a component of the construction-site machine, a communication module, and an evaluation unit. The communication module is set up to transmit the data acquired by the at least one sensor wirelessly to the evaluation unit. The evaluation unit is set up to receive and evaluate the data transmitted by the communication module. The evaluation unit is further set up to correlate the data with a mass of the construction materials and/or construction components transported by the construction-site machine.

Furthermore, the object is achieved according to the invention by a method of analyzing a construction project, comprising the following steps:
acquiring data relating to a component of a construction-site machine used in the construction project in an automatic manner via a sensor,
transmitting the acquired data to an evaluation unit, and
evaluating the transmitted data to obtain evaluation results, the transmitted data being correlated with a mass of the construction materials and/or construction components transported by the construction-site machine to evaluate the progress of the construction project, and/or construction-site machine data being derived from the transmitted data, in particular taking machine-specific data of the construction-site machine into account.

The basic idea of the invention is that the construction project, in particular the progress of the construction project, can be analyzed automatically at the construction site, so that efficiency can thus be increased. In the analysis of the construction project, among other things, the weight lifted by the construction-site machine, i.e. the corresponding mass of the transported construction materials or construction components, can be automatically derived by evaluating the data acquired by the sensor, which is also automatically acquired by the sensor. The progress of the construction project can be deduced from this information acquired by the sensor. In this respect, data providing information about how quickly the construction project is progressing can be automatically acquired via the at least one sensor.

Therefore, no manual input or documentation of the corresponding data is necessary.

The evaluation unit is set up, among others, to apply data analysis technologies and machine learning techniques to correlate the data acquired by the at least one sensor with the mass of construction materials and/or construction components transported by the construction-site machine. In other words, the data is interpreted using data analysis technologies and machine learning. For example, the data is processed using linear regression, polynomial regression, a so-called random forest method, a simple (artificial) neural network and/or a so-called convolutional neural network (CNN). The methods and techniques mentioned above are merely examples, as other methods may also be used. It is in particular possible to combine several methods and techniques.

Thus, the evaluation unit can evaluate the acquired data by means of, among other things, a regression analysis, for example a linear regression or a polynomial regression, and/or a neural network, for example a random forest, a simple (artificial) neural network, or a so-called convolutional neural network (CNN). More specifically, the acquired data can be correlated with a mass of the construction materials and/or construction components transported by the construction-site machine using the aforementioned techniques.

In this respect, in the method of analyzing the construction project, it is also provided to use the above-mentioned artificial intelligence or machine learning techniques to evaluate the transmitted data, i.e. to obtain the evaluation results. The data acquired by the at least one sensor can be sent to the evaluation unit by means of a communication technology using a mobile radio standard. The mobile radio standard is, for example, LTE, 5G or 5G-NR. In this respect, it is possible to provide the evaluation unit separately from the sensor or the communication module, as the data is transmitted wirelessly.

The data acquired by the at least one sensor can also be transmitted over long distances using other communication technologies, for example the LoRaWAN (“Long Range Wide Area Network”) standard, which is used in particular for IoT devices.

In other words, the recording assembly may be configured in several parts, as the sensor is provided on at least one component of the construction-site machine which moves, for example, with the construction materials and/or construction components to be transported.

The communication module and the at least one sensor may be accommodated in a separately formed recording device. The recording device may have a housing in which the communication module and the sensor are accommodated. The recording device is formed separately from the evaluation unit and is arranged, for example, on the construction-site machine. In contrast thereto, the evaluation unit is provided on an external server with which the recording device communicates via the communication module, that is, by means of the communication technology using the mobile radio standard.

The recording device can thus be designed as a so-called IoT device, which is subsequently coupled to the construction-site machine to automatically record data or information and make it available to the evaluation unit. In this respect, the recording device is a retrofit assembly arranged on an existing construction-site machine.

The evaluation unit provided on the external server may be provided as a software platform, which is for example made available as a web-based platform (“web platform”). This makes it possible for different groups of people to be provided with appropriate access authorization, in particular by means of a specific log-in. Different roles respectively enabling different access to the transmitted data may therefore be provided and stored.

The transmitted data, also referred to as raw data, and/or the evaluation results can be retrieved via the web-based platform. It is in particular possible that the transmitted data and/or evaluation results are provided in real time, so that a user is up to date with the latest information.

It may also be provided that the evaluation unit is equipped with a transmitting module so that a message is sent to a user via the transmitting module to inform the latter about current developments. For example, a construction site manager is automatically informed about the developments of the construction project since the last visit when entering the construction site.

For this purpose, it is first detected that the corresponding user is in the area of the construction site with a corresponding communication device, for example a cell phone or smartphone. It is then evaluated when the user was last at the construction site, so that developments are determined from the transmitted data for the corresponding period, in particular the corresponding evaluation results.

In principle, the data can thus be transmitted in various ways, for example via the web-based platform, a messenger service, by e-mail or by means of an application running on the user's cell phone or smartphone.

In particular, summaries may also be transmitted via the messenger service, by email, or the application, so that the user gets a quick overview and, if necessary, can retrieve the data in detail via the web-based platform.

Various data can be obtained from the transmitted data during evaluation. This involves technical data or maintenance data relating to the construction-site machine, but also management data relating to information concerning the progress of the construction project.

The data acquired by the sensor can thus be sent to the server(s) via the recording device configured as an IoT device, where the data can be (temporarily) stored and/or analyzed. In particular, the data is stored permanently, so that the data is available on a long term basis.

The recording device may further comprise a battery, in particular an accumulator. The battery can be used to supply the construction-site machine with energy at least temporarily, in particular in the event that the energy supply actually intended for the construction-site machine is not available (for a short time). In other words, supply bottlenecks can be bridged. It is therefore possible for the construction-site machine to be operated at least temporarily independently of its own electric connection.

The recording device can also comprise a data storage interface for a mobile data storage device, for example a memory card such as an SD card. It is thus possible that the data acquired by the at least one sensor are stored temporarily (for a short time) if, for example, communication via the communication module is interrupted or disturbed.

Furthermore, the recording device can additionally have a secure communication interface, for example a communication interface that conforms to the IEEE 802.11 standard, such as a WLAN or Wi-Fi interface. It is possible, among other things, via the secure communication interface that the mobile data storage device of the recording device can be accessed to operate or control it externally. In addition, the secure communication interface can be used to update the software (software update) of the recording device, in particular the data storage device.

One aspect provides that the at least one sensor is a movement direction sensor configured to detect the direction of movement of the component of the construction-site machine, and/or is a measurement sensor set up to detect a performance parameter of the component of the construction-site machine. In principle, a plurality of sensors may be provided, i.e., a movement direction sensor and a measurement sensor. Multiple measurement sensors or multiple movement direction sensors may also be provided.

The movement direction sensor indicates in which direction the component of the construction-site machine to which the movement direction sensor is assigned moves. The movement direction sensor can also be used to determine how high the corresponding component is above the ground, which in turn is an indication of how high the scaffolding, construction site or construction project is. In this respect, an indication can be made of the floor to which construction materials and/or construction components are transported, i.e., the corresponding mass with which the data from the at least one sensor is correlated.

The movement direction sensor may be designed as an air pressure sensor which detects the ambient air pressure of the component of the construction-site machine. The air pressure can be used to unambiguously detect the direction of movement of the component of the construction-site machine, since the change in air pressure is used to determine, among other things, whether the construction-site machine is currently moving up or down.

Alternatively, the movement direction sensor can be an acceleration sensor and/or a gyroscope. It is in this way also possible to determine the direction of movement of the corresponding component of the construction-site machine.

If the sensor is configured as a measurement sensor, corresponding performance parameters of the component of the construction-site machine can be detected. The performance parameter may be electrical performance parameters, for example electrical power, electrical current and/or electrical voltage, or mechanical performance parameters, for example torque, force, work and/or mechanical power.

In this respect, the measurement sensor may be configured as a current sensor, a voltage sensor, and/or an electrical power sensor. For example, the measurement sensor measures a current consumed by the construction-site machine, the evaluation unit correlating the current consumed with the weight lifted. The measurement sensor can also measure how long the construction-site machine moves and thus indicate the height of the construction project. Thus, it can be determined how fast the construction project progresses and how high the productivity on the construction site is, and at what points.

The duration of the performance parameter can thus be used to infer how long the construction-site machine moves to derive the height therefrom, especially if the speed at which the construction-site machine moves is known.

Similarly, the component of the construction-site machine may be a motor, such that the measurement sensor detects the speed or torque of the motor.

Furthermore, the at least one sensor may be a temperature sensor, a humidity sensor, a voltage sensor which detects the battery level of a battery, and/or a construction-site machine condition sensor which detects the condition of the corresponding construction-site machine.

Furthermore, the at least one sensor may be an ultrasonic sensor or an optical sensor, such as a camera. In this respect, images and/or videos can be recorded by the optical sensor, the correspondingly acquired data, i.e. the images and/or videos, being also transmitted to the evaluation unit via the communication module to be evaluated by the evaluation unit. In particular, the images and/or videos can be transmitted for documentation purposes.

For example, the optical sensor is used to optically detect the construction materials and/or construction components to be transported by the construction-site machine. The evaluation unit can be configured to automatically recognize the construction materials and/or construction components, corresponding data of the recognized construction materials and/or construction components being then taken into account.

An ultrasonic sensor may be advantageous in poor lighting conditions for the optical sensor, which means low light but also bright and thus dazzling light. The ultrasonic sensor can also be used to detect the construction materials and/or construction components to be transported by the construction-site machine. The evaluation unit may then be configured to automatically recognize the construction materials and/or construction components based on the data provided by the ultrasonic sensor, corresponding data of the recognized construction materials and/or construction components being then taken into account in the evaluation.

According to a further aspect, the recording assembly comprises a buffer memory set up to at least temporarily store the data acquired by the at least one sensor. Therefore, the acquired data can be temporarily stored if, for example, communication with the evaluation unit via the communication module is disturbed. The buffer memory may also be integrated in the recording device, i.e. within the housing of the recording device. The buffer memory may be a mobile buffer memory, for example a memory card, and/or a permanently installed buffer memory, for example a hard disk. The buffer memory may also be configured as a storage medium, such as a USB flash drive, interacting with a circuit board of the recording device.

Furthermore, the recording assembly, in particular the evaluation unit, may be configured to evaluate the data in real time. This can be ensured by means of fast communication between the recording device or the communication module and the evaluation unit, which is in particular configured separately from the recording device. In this respect, communication is provided at least by means of LTE to ensure evaluation in real time. The real-time evaluation can also be realized with a newer telecommunications standard, for example 5G-NR. It can thus be analyzed in real time how the progress of the construction project or site is. It is of course possible to use an older communication standard than LTE, especially to ensure compatibility with older devices.

A further aspect provides a current input interface and a current output interface, wherein the at least one sensor is arranged between the current input interface and the current output interface in the direction of current flow. In this respect, the sensor can determine electrical power parameters in a simple manner by the sensor accessing the electrical line present between the current input interface and the current output interface. The recording device may include the current input interface and the current output interface. For example, the recording device is formed as a plug-in coupler variant having a socket and a plug as corresponding interfaces.

Basically, a plug connector is the generic term for a socket and a plug, that is, a female connector and a male connector, respectively.

The plug-in coupler variant ensures that the corresponding recording device can be easily inserted into an existing power or retrofitted accordingly. The plug of an existing power supply of the construction-site machine can be removed from the associated socket so that the power supply is interrupted. The recording device configured as a plug-in coupler is then inserted into the interrupted power supply to restore the power supply. The recording device in the plug-in coupler variant corresponds to an adapter interposed or inserted into a power supply.

For example, the recording device is inserted between an inverter, in particular an inverter box housing the inverter, and an electric cable associated with the inverter. The installation can take place on a construction-site machine designed as a construction lift or construction hoist. In this respect, the electrical current for operating the construction-site machine flows via the recording device, which acquires corresponding data, in particular the current or electrical power consumption, the acquired data being transmitted to the evaluation unit via the communication module.

The female socket and the male plug can each be of three-phase design, in particular as counterparts for so-called protective contact connectors, also known as Schuko connectors.

The recording device, which is designed as a plug-in coupler variant, includes electronics designed to detect whether one or more phases of the three-phase plug connectors are used.

The recording device can also be configured as a case-type version, which is additionally arranged at the construction-site machine. The recording device configured in this way includes a housing. In addition, the recording device may include a transformer associated with the current input interface to provide power to the components of the recording device. The components may be the communication module and/or the sensor.

As already discussed, the current input interface and/or the current output interface may be configured in a three-phase manner. The recording device may further be configured to automatically detect the number of phases used. In this respect, the recording device may optionally be used with a single-phase construction-site machine or a three-phase construction-site machine, this being automatically detected by the recording device.

A further aspect provides that the recording assembly comprises a time measurement unit, the evaluation unit being in particular set up to determine a time measurement data profile of the data acquired by the measurement sensor. In this way, a current consumption profile of the construction-site machine can be determined by recording the current consumption over time to create a profile. This can be used to acquire information on how long the construction-site machine consumes current. If the construction-site machine is known because, for example, it can only travel in a vertical direction, the distance or height traveled can be derived from the recorded time. This is particularly possible if the speed at which the construction-site machine moves is known.

It is also possible to distinguish whether the construction-site machine is currently moving up, down, to the left or to the right based on the level of the detected current consumption.

Furthermore, an additional sensor, such as a pressure sensor or other sensor, can be used or combined with the current consumption sensor to deduce the direction of travel.

In principle, productivity can also be recorded due to the time measurement unit, since the time spent on a particular activity can be measured. This can be, for example, the loading or unloading of the construction-site machine, since at this time there is no power consumption or other type of performance of the construction-site machine. Loading can be distinguished from unloading by the fact that the mass to be transported differs accordingly after loading or unloading.

Furthermore, the object is achieved according to the invention by a construction-site machine having a recording assembly of the aforementioned type, the sensor being arranged on a movable component of the construction-site machine which serves to transport construction materials and/or construction components. In this respect, the sensor itself is also moved when the construction materials and/or construction components are moved. In this way, it is possible in a simple manner to derive the height covered and/or the corresponding weight lifted via the sensor.

Furthermore, an identification means may be provided on the construction-site machine, the identification means being connected to the communication module. The connection may be designed as a wireless or wired connection. For example, there is a Bluetooth or an RFID connection between the identification means and the communication module. The identification means may be a so-called near field communication tag (NFC tag). With the NFC tag, a worker on the construction site can communicate in a simple manner using a mobile terminal, for example a smartphone.

For example, the identification means is arranged on the construction-site machine, in particular an inner side, so that the worker who wants to transport construction materials or construction components with the construction-site machine must first scan a mobile terminal or a scanning device before the recording device forwards the current to the construction-site machine. In this way, workers cannot forget to scan the mobile terminal or scanning device, and the corresponding data is automatically transmitted to the evaluation unit, so that, among other things, it is detected which type of workers on the construction site use the construction-site machine, in particular also the frequency.

It is thus also possible to indirectly detect which type of construction material or construction components are transported, as these are assigned to the type of worker. This makes the construction process visible, and it becomes clear which trades on the construction site use the construction-site machine the most.

In the case of a smartphone communicating with the identification device, an application can be installed on the smartphone which automatically assigns the data to the correct construction site. Furthermore, any notes written in the application on the smartphone can be assigned to the construction site, and any photos taken of the construction site can also be assigned to the construction site.

Basically, notes, such as problems with the construction project, photos, and/or other information, all available as data on the smartphone, can be transmitted to the evaluation unit. This can be done directly via the smartphone or via the communication module, i.e. the construction-site machine, provided that the smartphone has a connection thereto.

In addition, the object is achieved according to the invention by a recording system comprising a plurality of recording assemblies of the aforementioned type and/or a plurality of construction-site machines of the aforementioned type, a common evaluation unit being provided. In this respect, several recording assemblies may be provided at different construction sites. It is also possible that several construction-site machines of one construction site or several construction-site machines of several construction sites are part of the recording system. The corresponding sensors respectively transmit their data to a common evaluation unit, for example a central server, which evaluates the respectively acquired data and makes it available centrally. It is thus possible, for example, that a construction contractor having several construction projects at the same time can monitor the different construction projects simultaneously, in particular the progress thereof. For this purpose, the evaluation unit can be designed to visualize corresponding evaluation data so that it is made available in a simple manner.

A further aspect provides a mobile terminal which is set up to acquire additional data and transmit it to the evaluation unit. The terminal can be carried or operated by a construction worker at a corresponding construction site. Images which are transmitted as additional data to the evaluation unit can be captured by means of the mobile terminal. In this respect, the mobile terminal may be a smartphone. In addition to photos, further data, for example notes, videos or other information can also be transmitted from the smartphone to the evaluation unit.

The smartphone can at the same time be set up to scan the identification means provided on the construction-site machine via its camera. This can also be done via wireless communication, provided that the identification means is an NFC tag.

The method can basically be used to analyze the productivity of the construction project.

In principle, subsequent information can thus be provided automatically with an update rate in real time, for example the performance or productivity of a worker and/or a team.

When evaluating the transmitted data, basically different evaluation results can be obtained.

In particular, technical data of the construction-site machine are determined, namely, among other things, the operating hours of the construction-site machine are determined, the average load transported by the construction-site machine, for example as a percentage of the utilization or as a mass in kg, the total load transported by the construction-site machine, the total height covered over an adjustable or selectable period of time, the maximum height reached or covered, the number of cycles performed by the construction-site machine.

Construction-site machine data of the construction-site machine can also be determined during evaluation. In this case, machine-specific data of the construction-site machine can be taken into account. In this respect, it is possible to determine the time or the operating hours until the next maintenance of the construction-site machine. For this purpose, information or data of the construction-site machine can be taken into account, namely the so-called machine-specific data of the construction-site machine, which indicate when the last maintenance was performed. The (total) mass transported by the construction-site machine can also be taken into account, as this has an influence on the wear of the construction-site machine. In this respect, maintenance data can be determined.

In addition, status data of the construction-site machine or of components of the construction-site machine can also be determined when evaluating the transmitted data. This can be the temperature, the speed, the torque, the charge state of the battery or similar information.

In principle, the maintenance data, the status data and the technical data therefore each represent construction-site machine data which can be determined from the transmitted data, i.e. the raw data, during evaluation.

One aspect provides that the transmitted data is extrapolated during evaluation. This makes it possible to obtain information relating to the progress of the construction project, for example management data, from the acquired and transmitted data, i.e. the raw data. The transmitted data is data acquired directly by the sensor, which is why it is also referred to as raw data.

This raw data can be exclusively extrapolated during the analysis, or first extrapolated and then evaluated to obtain the evaluation results. In this respect, the evaluation results can be extrapolated raw data, i.e. an extrapolated value of a quantity acquired by the sensor.

However, the evaluation results can also be quantities derived from the raw data which are not directly acquired by the sensor.

In principle, the transmitted data can first be evaluated to obtain intermediate evaluation results, i.e., quantities which are not directly measured, and the intermediate evaluation results can be further evaluated, for example, extrapolated. Therefore, quantities which have not been directly acquired by the sensor can also be extrapolated.

For example, the maximum height reached, in particular the maximum height covered (by the construction-site machine or the robot), can be detected by means of sensors. The total transported mass can also be determined by summing the transported masses during evaluation. The information can then be used to draw conclusions about the progress of the construction project, i.e. corresponding management data can be determined during evaluation.

Due to the extrapolation of the data, it is thus possible to obtain evaluation results which relate to the future.

For example, a series of measured values is continued beyond an observed point in time. This makes it possible, among other things, to determine how much construction material and/or construction components, in particular the associated mass, can realistically be transported in a defined period of time in the future. By extrapolating the construction-site machine data, it is also possible to determine whether there is a high level of wear, so that maintenance work will be necessary, which in turn could lead to a delay.

A forecast is therefore made for the future, for which purpose the extrapolation of the transmitted data is carried out. This allows a development trend to be taken into account. The evaluation results obtained on the basis of the extrapolation therefore refer to the future.

With the extrapolation, in particular the consideration of the development trend, more exact results can be obtained than on the basis of a target/actual comparison at a current time.

In addition, when evaluating the transmitted data, it is possible to determine how high the working time or efficiency has been, for example the utilization of the available loading capacity of the construction-site machine.

It is also possible to acquire the evaluation results of several construction projects and/or that evaluation results of at least one already completed construction project (“historical data”) are used in the analysis of the at least one construction project. An overview can thus be created which of the multiple construction projects is the most productive. A construction contractor is thus able to prioritize or optimize the construction projects accordingly. It is therefore possible to analyze which type of construction project should be preferred in the future.

The inclusion of the historical data, i.e. the evaluation results of construction projects that have already been completed, also makes it possible to establish a relationship with the data of the current construction project. It can thus also be checked whether an efficiency enhancement or improvement measure carried out prior to the current construction project has the desired success.

The evaluation results can be visualized so that, for example, the construction contractor, the construction company, the scaffolding company and/or another construction company can easily see which construction projects are how productive and at which points. This makes it possible to control the productivity in a simple way.

In principle, the evaluation results can be used to monitor a current project planning, carry out a future project planning, predict maintenance periods of the construction-site machine and/or generate recommended actions. If, for example, the same type of construction-site machine is used on several construction sites, so-called “predictive maintenance” can be provided, as maintenance periods of the corresponding type of construction-site machine can be determined on the basis of the acquired data, which can be transferred to other construction projects. It is also possible to draw conclusions from one type of construction-site machine to another type of construction-site machine, so that the acquired data can be used to determine maintenance periods, especially also for other types of construction-site machines. Similarly, a current or ongoing project planning can be continuously monitored by evaluating the evaluation results accordingly. The evaluation results can also be used for future project planning to estimate the productivity or duration thereof.

It is also possible to generate recommended actions to adapt working processes, in particular to make them more efficient. Based on the analysis of the use of the transport capacities of the construction-site machine, a strategy can be recommended on how to transport the construction material more optimally, for example in a different sequence.

Algorithms (artificial intelligence) can be used in determining recommended actions, for example machine learning techniques. This is particularly advantageous when multiple data are processed, in particular from multiple construction-site machines or from multiple sources in general. Machine learning techniques can use supervised techniques such as support vector machine techniques (SVM techniques) or k-nearest neighbor algorithms, and unsupervised techniques such as neural networks.

Based on the data and the evaluation thereof, i.e. the evaluation of the progress of the construction project, it is also possible to analyze whether a construction project has been planned correctly and the cost structure thereof calculated correctly. This makes it possible to create project plans for future construction projects which match the actual course of the construction site.

Based on the current or previous course of a construction project, for example how much weight per hour was transported, it is possible to predict how the course of the construction project will continue. For this purpose, statistical and machine learning methods can be used, which have previously been determined accordingly with test data.

Depending on the previous course, in particular on characteristic points such as heights and/or depths or the distinctiveness thereof, machine learning or statistical methods can be used to predict how the construction project will continue. Among other things, it can be predicted how long the construction project will last.

In addition, based on these facts, suggestions and/or indications can be issued on how to speed up the construction project. For example, it is suggested that more mass or weight per trip should be transported with the corresponding construction-site machine. This can be detected accordingly via the level detected by the sensor, i.e. that of the current consumption.

In this respect, it can be recognized on the basis of the acquired data that on average too little mass or weight has been transported per trip in the previous course of the construction project.

It can also be suggested that a different construction-site machine, in particular a transport aid, should be used in the future.

An indication can also be given that more personnel or a different team should be deployed.

It can also be recognized on the basis of the acquired data that an obstacle is present which should be removed.

Furthermore, an indication can be given that there should be (additional) access to electricity at the construction site or that this is required.

The evaluated data, i.e. the productivity data, about the at least one construction project, in particular several construction projects, are stored so that these data can be viewed for future construction projects. It is thus possible to understand how long certain construction projects or even construction phases have taken, which can improve the planning of upcoming construction projects.

In principle, the construction-site machine may be a transport aid, in particular a winch, a construction hoist, a construction lift, a crane and/or a robot.

### BRIEF DESCRIPTION OF THE DRAWINGS

Further advantages and features of the invention will become apparent from the description below and from the drawings to which reference is made and in which:

FIG. 1 shows a schematic representation of a recording system according to the invention, comprising a plurality of construction-site machines according to the invention,

FIG. 2 schematically shows a recording device of a recording assembly according to the invention in accordance with a first embodiment,

FIG. 3 schematically shows a recording device of a recording assembly according to the invention in accordance with a second embodiment,

FIG. 4 shows a schematic representation of a construction-site machine according to the invention,

FIG. 5 shows an overview of the transmitted data and/or the evaluation results obtained, for example, by means of the recording system according to FIG. 1,

FIG. 6 shows an overview of maintenance data which can be retrieved via a web-based platform,

FIG. 7 shows a representation of the web-based platform via which a user can retrieve, among other things, the transmitted data and/or the evaluation results, and

FIG. 8 shows an overview of an exemplary daily report.

### DETAILED DESCRIPTION OF THE INVENTION

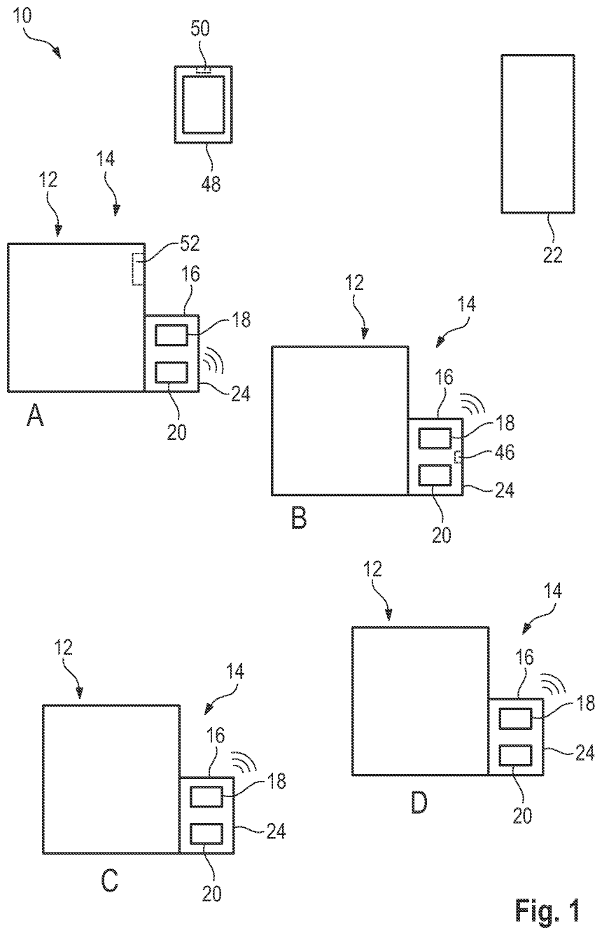

FIG. 1 shows a recording system 10 comprising a plurality of construction-site machines 12 which can be used on different construction projects at different construction sites A-D. It is basically also possible to use a plurality of construction-site machines 12 per construction site A-D. However, for the sake of simplicity, only one construction-site machine 12 per construction site A-D is shown here.

The construction-site machines 12 are, for example, construction hoists, construction lifts, cranes, winches or scaffold transport systems which are used on a construction site where, for example, a high-rise building or another building is constructed or renovated.

At least one recording assembly 14 is provided at each of the respective construction sites A-D, and is associated with at least one construction-site machine 12 for each construction site A-D.

The respective recording assembly 14 comprises a recording device 16 having a sensor 18 and a communication module 20. The sensor 18 automatically acquires data relating to a component of the construction-site machine 12 used to transport the construction materials or construction components.

Furthermore, each recording assembly 14 includes an evaluation unit 22 which is configured separately from the recording device 16.

In the embodiment shown, a common evaluation unit 22 is provided for all recording assemblies 14.

The recording device 16 communicates with the evaluation unit 22 via the communication module 20. In this respect, the communication module 20 is set up to transmit the data acquired by the at least one sensor 18 to the evaluation unit 22 in a wireless manner.

The evaluation unit 22 is, for example, an external server which is set up to process the correspondingly received data, that is, the data transmitted by the recording assembly (assemblies) 14.

Therefore, the evaluation unit 22 receives the data transmitted by the communication module 20 and evaluates it. In this regard, the evaluation unit 22 may use data analysis technologies or machine learning techniques to correlate the received data with a mass of the construction materials or construction components transported by the construction-site machine 12. In the simplest manner, the obtained data is correlated with the mass transported by the construction-site machine 12 using a linear equation.

The common evaluation unit 22 receives corresponding data from the plurality of sensors 18 associated with the recording devices 16, wherein the data can be analyzed in the common evaluation unit 22 and made available via a web-based platform so as to be adapted to be viewed and evaluated by a user of the recording system 10.

In addition to the construction-site machines 12, other devices or sources may also be provided which transmit data to the evaluation unit 22 accordingly.

In this respect, the evaluation unit 22 is set up to accumulate the transmitted data from diverse sources, in particular data from a plurality of construction sites, for example a plurality of current construction sites and/or from already completed construction sites. Therefore, the transmitted data taken into account by the evaluation unit 22 in the evaluation may also be data transmitted from a data storage device on which the determined data of an already completed construction project is stored.

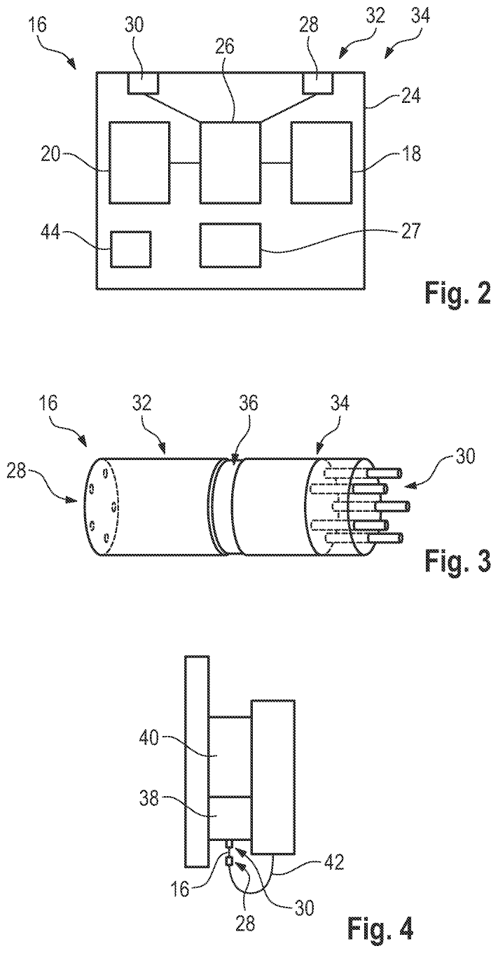

It is apparent from FIG. 2 that the recording device 16 shown there has a housing 24 in which the communication module 20, the sensor 18 and a transformer 26 are accommodated.

The recording device 16 may further comprise a battery 27, in particular an accumulator. Energy stored temporarily in the battery 27 may be used to supply the recording device 16 with energy. However, energy can also be supplied to the construction-site machine 12 at least temporarily, in particular in the event that the energy supply actually provided for the construction-site machine 12 is not available (for a short time).

In addition, the recording device 16 comprises a current input interface 28 and a current output interface 30, via which the recording device 16 can be coupled in a simple manner to an existing construction-site machine 12.

In this respect, the recording device 16 is a so-called IoT device 32, which is designed as a retrofit assembly 34, so that it can be retrofitted in a simple manner.

The transformer 26 is coupled to the current input interface 28 so that the electrical power flowing between the current input interface 28 and the current output interface 30 can be converted, at least in part, via the transformer 26 into supply energy for the components of the recording device 16, such as the communication module 20 and/or the sensor 18.

The embodiment of the recording device 16 shown in FIG. 2 is also referred to as case-type version.

FIG. 3 shows an alternative embodiment in which the recording device 16 is configured as a plug-in coupler version.

In contrast to the case-type version shown in FIG. 2, the plug-in coupler version may not comprise a housing 24 which completely surrounds all components of the recording device 16 or on the housing wall of which the current input interface 28 and the current output interface 30 are formed.

The recording device 16 which is configured as a plug-in coupler version has electronics 36 comprising, for example, at least the sensor 18. The electronics 36 can communicate with a separately formed communication module 20, so that the data acquired by the sensor 18 is transmitted to the communication module 20, from where the data is sent to the evaluation unit 22.

The communication module 20 may also be integrated in the electronics 36.

However, the electronics 36 may be accommodated in a (small) housing, from which the current input interface 28 and the current output interface 30 extend, in particular via a corresponding line section.

The current input interface 28 and the current output interface 30 may in principle be of single-phase, two-phase or three-phase design, so that they can be coupled to a three-phase construction-site machine 12. In particular, the current input interface 28 and the current output interface 30 may be configured so as to provide both single-phase and three-phase connections.

For example, the current input interface 28 and the current output interface 30 are configured as sockets which can receive either a single-phase or three-phase plug.

The plug-in coupler version of the recording device 16 can be easily integrated into an existing construction-site machine 12, as is apparent from FIG. 4, in which a construction site hoist is shown schematically.

For this purpose, an existing electrical plug-in connection of the construction-site machine 12 is briefly interrupted, the plug-in coupler version of the recording device 16 being interposed.

In other words, the plug-in coupler version of the recording device 16 is an adapter which can be integrated in a simple manner, the current used to supply the construction-site machine 12 flowing via the recording device 16 designed as an adapter.

In the embodiment shown, the recording device 16 is inserted between an inverter 38, in particular an inverter box housing the inverter 38 and arranged upstream of a motor 40, and an electric cable 42 associated with the inverter 38. The installation may be performed in a similar manner on a differently configured construction-site machine.

In this respect, the electrical current for operating the construction-site machine 12 flows via the recording device 16, which acquires corresponding data, for example the current or electrical power consumption, by means of the electronics 36, in particular the sensor 18, the acquired data being transmitted to the evaluation unit 22 via the communication module 20.

The recording device 16 may in principle comprise a time measurement unit 44, via which, among other things, the duration of movement of the construction-site machine 12 can be detected.

In particular, based on the data transmitted by the time measurement unit 44, the evaluation unit 22 determines a time measurement data profile of the data acquired by the sensor 18, for example a current consumption profile, provided that the sensor 18 acquires a current consumed by the construction-site machine 12.

It can be derived from the current consumption profile how long the construction-site machine 12 has consumed a certain current, to conclude therefrom the distance covered, in particular the height of the construction-site machine 12.

Based on the acquired height that the construction-site machine 12 has traveled, it is possible to derive the height of the corresponding construction project, which in turn makes it possible to make statements regarding the progress of the construction project.

In principle, the at least one sensor 18 can be a movement direction sensor which is set up to detect the direction of movement of the component of the construction-site machine 12. Therefore, the movement direction sensor indicates the direction in which the component of the construction-site machine 12 moves, i.e., whether movement is upward or downward.

The movement direction sensor may be configured as an air pressure sensor which detects the ambient air pressure of the component of the construction-site machine 12. This can be used to easily determine whether the component moves up or down.

The movement direction sensor may also be configured as an acceleration sensor and/or a gyroscope.

Furthermore, the sensor 18 may in principle be a measurement sensor set up to detect a performance parameter of the component of the construction-site machine 12. This may be an electrical performance parameter and/or a mechanical performance parameter.

The electrical power parameter is to be understood as the electrical power, the electrical current and/or the electrical voltage which is or will be consumed by a component of the construction-site machine 12 to transport construction materials or construction components, for example.

In contrast thereto, a mechanical power parameter is to be understood as a torque, force, work, or mechanical power which must also be applied by a component of the construction-site machine 12 to transport the construction materials or construction components. In this respect, the sensor 18 may be associated with a motor of the construction-site machine 12 to detect the applied force or torque.

The data acquired by the evaluation unit 22, and the evaluation data can be provided to different users in different categorized ways, so that different user groups have different access to the corresponding data.

The user groups or roles may be referred to, by way of example, as “admin”, “admin company”, and “user company”, which have access to the data stored or evaluated in the evaluation unit 22 via a corresponding front end.

The common evaluation unit 22 may also be cloud-based, cooperating with a plurality of recording assemblies 14 to obtain corresponding data from different construction sites.

The construction-site machines 12, which are, for example, robots of a scaffold transport system, transmit their data to the evaluation unit 22 in encrypted form. If this is not desired, the data may be transmitted in unencrypted form.

Therefore, the evaluation unit 22 provided on the external server can be designed as a software platform which is available, for example, as a web-based platform. This makes it possible for different groups of people or user groups (roles) to be respectively provided with appropriate access authorization, in particular by means of a specific log-in. Different user groups (roles) can therefore be provided and stored, each with different access to the data transmitted and stored on the server.

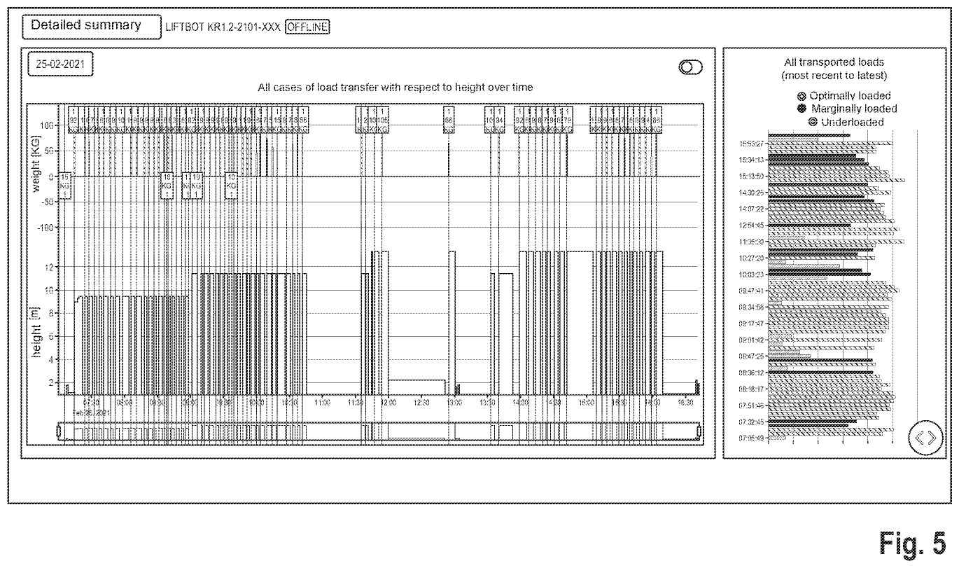

FIG. 5 shows an overview of the data or evaluation data acquired by the evaluation unit 22, in particular how these can be retrieved accordingly.

In the exemplary overview, an overview is illustrated which shows all load transfer cycles of a construction-site machine 12, exemplarily a robot such as the “Liftbot”, in a defined time period. The respective cycles are indicated with the corresponding height covered as well as the weight. In addition, a time stamp is assigned to each cycle.

In addition, an “efficiency overview” is shown, in which the respective loading is evaluated. For this purpose, the corresponding evaluation results are used.

The evaluation distinguishes between three categories: underloading, marginal overloading and optimum loading. The respective categories are assigned to corresponding value ranges.

By means of further overviews, the evaluation or analysis data can also be made available in a visualized form so that a user can easily acquire the productivity of at least one construction project at a construction site A-D.

In a general overview, the user can for example see all of his/her construction projects on a map to get an overview of the currently available construction projects or construction sites. It is also possible to display only the largest construction projects on a map.

Furthermore, the user can select which of his/her construction projects should be displayed. In this respect, the representation can be individualized.

The user can also select one of the several construction projects to be viewed in detail. In the detailed view, the user can already see first productivity or analysis data.

The user can view the productivity or analysis data in even more detail, for example to find out how much material or components, in particular the weight thereof, have been transported in a certain period of time. Similarly, the height that the material or components have traveled can be displayed.

A list view is also possible, in which all current construction projects and/or construction sites of a user are represented in a list.

In addition to technical information, commercial information can also be displayed in this list, such as previous turnover, profit, costs of the construction project or similar. A total expected profit or turnover of the construction project can also be listed. It is also possible to determine and display a prediction regarding total cost and/or total profit.

The commercial information is related to the technical information, namely the transported weight or mass, and also other data, such as the weather. In case of very bad weather, construction can only be carried out more slowly or not at all, which has a corresponding influence.

Generally, due to the time measurement units 38 assigned to the recording assemblies 14, corresponding downtimes can be determined and displayed, by means of which the productivity can be seen accordingly.

In principle, the data regarding the productivity can be used to monitor a current project planning, to perform a future project planning, and/or to predict maintenance periods of the construction-site machine 12.

In this respect, the actual state of a construction project can be compared with the planned progress (target state), and corresponding deviations can be displayed.

In principle, the recording assembly 14, in particular the recording device 16, can also have a buffer memory 46 (see FIG. 1), in which, among other things, the acquired data is temporarily stored if, for example, communication with the evaluation unit 22 via the communication module 20 is disrupted.

The buffer memory 46 is designed, for example, as a memory card, a USB flash drive or a hard disk. In this respect, the recording device 16 has a data storage interface, for example in the form of a slot for the memory card.

In principle, a secure communication interface may also be provided via the communication module 20, for example a communication interface conforming to the IEEE 802.11 standard. Via the secured communication interface, it is possible, among other things, that the mobile data storage device or buffer memory 46 of the recording device 16 can be accessed to operate or control the latter externally.

Furthermore, it can be seen from FIG. 1 that the recording system 10 comprises a mobile terminal 48 which is set up to acquire additional data and to transmit it to the evaluation unit 22.

The mobile terminal 48 is, for example, a smartphone.

The mobile terminal 48 can be used to transmit notes, for example, problems with the construction project, photos, and/or other information, all of which are available as data on the mobile terminal 48, to the evaluation unit 22.

The mobile terminal 48 may also include a near field communication (NFC) interface 50 which can be used, for example, to recognize an identification means 52 on the construction-site machine 12, such as an NFC tag.

For example, the identification means 52 is provided on the construction-site machine 12, the identification means 52 being connected to the communication module 20 of the construction-site machine 16, in particular wirelessly, for example by means of a Bluetooth or an RFID connection, or in a wired manner.

For example, the identification means 52 is located on an inner side of the construction-site machine 12, in particular a construction hoist or similar, so that a worker who wants to transport construction materials or construction components with the construction-site machine 12 must first scan his/her mobile terminal 48 before the recording device 16 forwards the current to the construction-site machine 12.

In this way, workers cannot forget to scan the mobile terminal 48, and the corresponding data is automatically transmitted to the evaluation unit 22 so that, among other things, it is detected which type of workers on the construction site use the construction-site machine 12, in particular also the frequency.

In principle, a plurality of sensors 18 may be provided via which data is acquired. The additional sensors 18 may also be configured as an optical sensor such as a camera, a temperature sensor, a humidity sensor, a voltage sensor which detects the battery level of a battery, and/or a construction-site machine condition sensor.

As explained above, the acquired data and the correspondingly evaluated data or evaluation results can be visualized.

In principle, it is possible to carry out a method of analyzing a construction project. For this purpose, data relating to a component of the construction-site machine 12 used in the construction project is for example acquired in an automatic manner via the sensor 18. The acquired data is then transmitted to the evaluation unit 22.

The correspondingly transmitted data is then evaluated by the evaluation unit 22 to obtain evaluation results. Here, the transmitted data can be correlated with a mass of the construction materials and/or construction components transported by the construction-site machine 12 to evaluate the progress of the construction project. Alternatively or additionally, construction-site machine data can be derived from the transmitted data, in particular taking machine-specific data of the construction-site machine 12 into account.

Furthermore, data from other construction-site machines 12 or other sources can also be acquired and transmitted to the evaluation unit 22. Therefore, the evaluation unit 22 can accumulate a plurality of data, in particular from different sources, and use it for evaluation.

The transmitted data can in principle be extrapolated, for example to obtain evaluation results relating to the future.

When evaluating the transmitted data, basically different evaluation results can be obtained. These can be technical data of the construction-site machine 12, maintenance data of the construction-site machine 12, and/or status data of the construction-site machine 12.

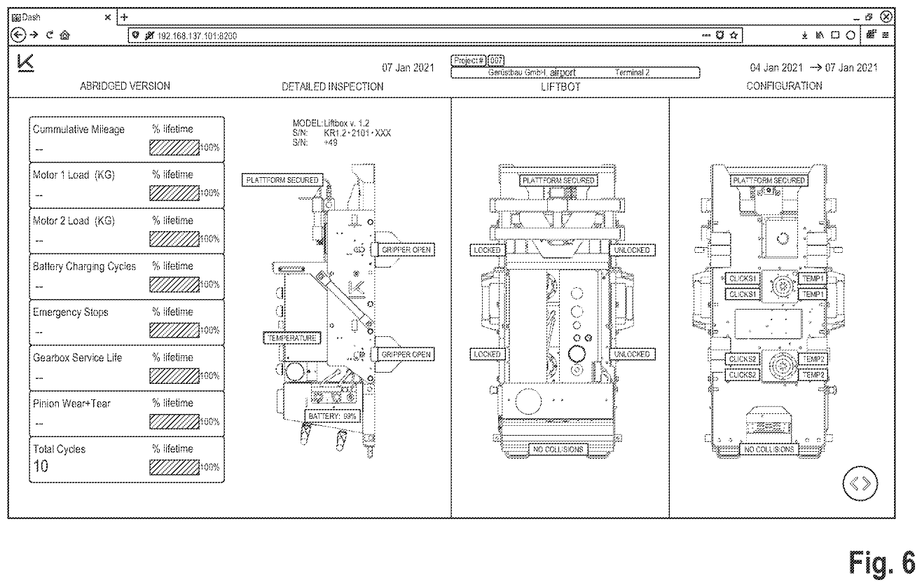

FIG. 6 shows an example of an overview which illustrates corresponding maintenance data of the construction-site machine 12, in particular remote maintenance data enabling remote diagnosis.

On the left side of the overview according to FIG. 6, the expected remaining service life of various components of a construction-site machine 12, for example of a robot such as the “Liftbot”, is displayed.

On the right side, the overview shows live data from the sensors of the construction-site machine 12. This can be used to display states of components, for example “open”, “closed”, “secured” or “unsecured”, or indications regarding any problems, for example temperature problems. Depending on the severity of the problem, this can be coded differently, for example by means of a different color coding, namely “green”, “orange” or “red”.

During the evaluation of the transmitted data, so-called management data can also be determined, concerning, for example, information regarding the progress of the construction project.

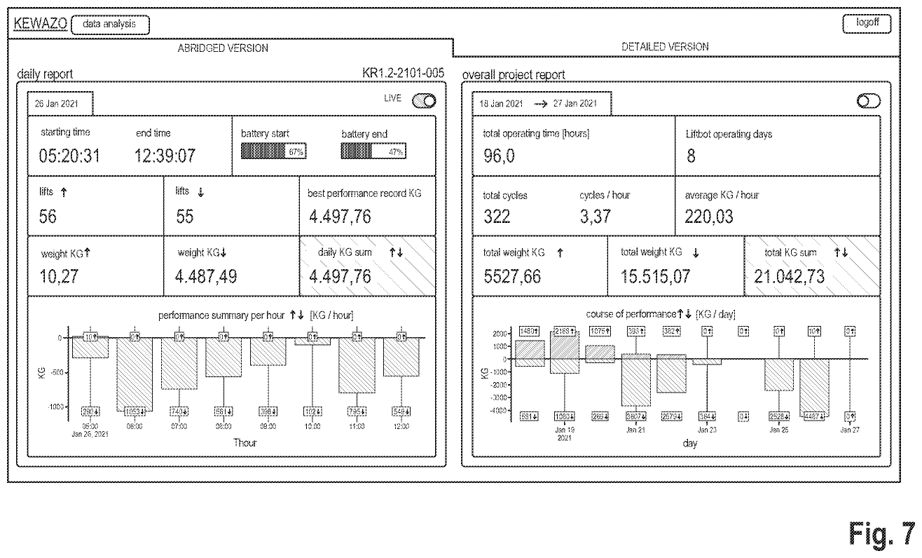

The transmitted data and/or the evaluation results can be made available to a user via the web-based platform, as shown by way of example in FIG. 7.

Among other things, cumulative data are shown there, indicating the total operating time, the operating days, the number of trips (“total cycles”), the trips per hour (“cycles/hour”), the total transported load (“total weight KG”), in particular in both directions individually and summarized, as well as the average weight per hour (“average KG/hour”). In addition, a corresponding performance curve is given for the individual days. Furthermore, the maximum height covered (“height (m)”), the weight utilization of the construction-site machine 12 (“% of maximum load capacity”) and the time utilization of the construction-site machine 12 (“activity period %”) can also be indicated.

In addition to the cumulative data which can be displayed, other data or information which is of interest to the user can be displayed, in particular a daily report or a report updated on a daily basis.

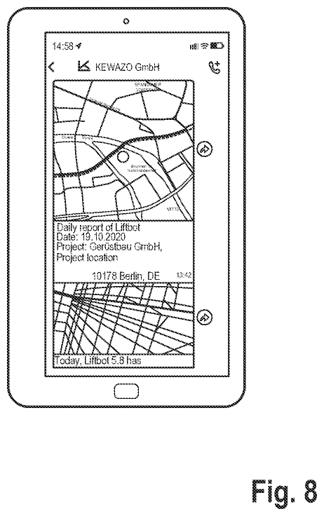

An exemplary daily report is shown in FIG. 8.

In principle, the daily report can be sent in various ways to a recipient, for example to the person responsible for the construction site. The daily report contains, among other things, information about the project and the work done by the construction-site machines 12 provided there.

The corresponding information can be obtained from the evaluation results.

In particular, the corresponding data or information to be presented to the user can be selected. The corresponding setting can be assigned to a profile or role and preset accordingly, so that data or information is displayed to different users in a customized manner.

Technical data can also be retrieved via the web-based platform, for example the temperature of the motor of the construction-site machine 12, the speed of the construction-site machine 12, the torque of the construction-site machine 12, as well as the charge state of the battery of the construction-site machine 12 or a charge state of the battery of the construction-site machine 12 at the beginning (“battery start”) are indicated, in particular the corresponding temporal progression of these technical data.

The graphs of these technical data may have been calculated accordingly during evaluation of the transmitted data to obtain the evaluation results that can be displayed. The graphs shown are construction-site machine data derived from the transmitted data during evaluation.

The progress of the construction project is also shown, the transported weight and the corresponding height being respectively displayed over time, so that it can be retraced when which mass has been transported over which height.

Therefore, the method can be used to analyze the construction project, in particular automatically. A current project planning can be monitored, a future project planning can be carried out, maintenance periods of the construction-site machine 12 can be predicted, and/or recommended actions can be generated based on the analysis, in particular the evaluation results obtained.

1. A recording assembly for a construction-site machine transporting construction materials and/or construction components on a construction site, comprising at least one sensor which is set up to automatically acquire data relating to a component of the construction-site machine, a communication module, and an evaluation unit, wherein the communication module is set up to transmit the data acquired by the at least one sensor wirelessly to the evaluation unit, and the evaluation unit is set up to receive and evaluate the data transmitted by the communication module, wherein the evaluation unit is further set up to correlate the data with a mass of the construction materials and/or construction components transported by the construction-site machine.

2. The recording assembly according to claim 1, wherein the at least one sensor is a movement direction sensor, which is set up to detect the direction of movement of the component of the construction-site machine, and/or a measurement sensor, which is set up to detect a performance parameter of the component of the construction-site machine.

3. The recording assembly according to claim 1, wherein the recording assembly comprises a buffer memory which is set up to at least temporarily store the data acquired by the at least one sensor.

4. The recording assembly according to claim 1, wherein the recording assembly, via the evaluation unit, is configured to evaluate the data in real time.

5. The recording assembly according to claim 1, wherein a current input interface and a current output interface are provided, wherein the at least one sensor is arranged between the current input interface and the current output interface in a direction of current flow.

6. The recording assembly according to claim 1, wherein the recording assembly comprises a time measurement unit, wherein the evaluation unit is set up to determine a time measurement data profile of the data acquired by the sensor.

7. A construction-site machine comprising the recording assembly according to claim 1, wherein the sensor is arranged on a movable component of the construction-site machine which serves to transport the construction materials and/or the construction components.

8. The construction-site machine according to claim 7, wherein an identification means is provided on the construction-site machine, wherein the identification means is connected to the communication module.

9. A recording system comprising a plurality of the recording assemblies according to claim 1, and/or a plurality of construction-site machines comprising the recording assembly wherein the sensor is arranged on a movable component of the construction-site machine which serves to transport the construction materials and/or the construction components, wherein a common evaluation unit is provided.

10. The recording system according to claim 9, wherein a mobile terminal is provided which is set up to acquire additional data and to transmit it to the evaluation unit.

11. A method of analyzing a construction project, comprising steps of:
acquiring data relating to a component of a construction-site machine used in the construction project in an automatic manner via a sensor,
transmitting the acquired data to an evaluation unit, and
evaluating the transmitted data to obtain evaluation results, the transmitted data being correlated with a mass of construction materials and/or construction components transported by the construction-site machine to evaluate progress of the construction project, and/or construction-site machine data being derived from the transmitted data to take machine-specific data of the construction-site machine into account.

12. The method according to claim 11, wherein the transmitted data is extrapolated during evaluation.

13. The method according to claim 11, wherein the evaluation results of several construction projects are collected and/or in that evaluation results of at least one already completed construction project are used in the analysis of the at least one construction project.

14. The method according to claim 11, wherein the evaluation results are used to monitor a current project planning, to perform a future project planning, to predict maintenance periods of the construction-site machine, and/or to generate recommended actions.

15. The method according to claim 11, wherein historical data from a plurality of construction-site machines and/or historical data from a plurality of sources are used in the analysis of the construction project.
